(19) United States
(12) Patent Application Publication
(10) Pub. No.: US 2025/0001332 A1
(43) Pub. Date: Jan. 2, 2025

(54) DUAL STAGE ADVANCED FUEL WATER SEPARATOR

(71) Applicant: Cummins Filtration Inc., Nashville, TN (US)

(72) Inventors: Wassem Abdalla, Fishers, IN (US); Jayant Singh, Pune (IN); Sagar Padale, Pune (IN)

(73) Assignee: Cummins Filtration Inc., Nashville, TN (US)

(21) Appl. No.: 18/884,074

(22) Filed: Sep. 12, 2024

Related U.S. Application Data
(63) Continuation of application No. PCT/US2023/015106, filed on Mar. 13, 2023.

(30) Foreign Application Priority Data
Mar. 16, 2022 (IN) 202241014381

(51) Int. Cl. B01D 29/58; B01D 17/04; B01D 36/00

(52) U.S. Cl. CPC B01D 29/58; B01D 17/045; B01D 36/006; B01D 2201/291; B01D 2201/347; B01D 2239/0428

(57) ABSTRACT

A dual stage fuel water separator filter is provided. The filter includes a first stage and a second stage. The first stage includes a first media pack and a first coalescing wrap. The first media pack is coupled to a first upper endcap and a first lower endcap. The first coalescing wrap is coupled proximate to an inner surface of the first media pack and is coupled to both the first upper endcap and the first lower endcap. The second stage is positioned radially within the first stage and includes a second media pack and a second coalescing wrap. The second media pack is coupled to a second upper endcap and a second lower endcap. The second coalescing wrap is coupled proximate to an inner surface of the second media pack and is coupled to both the second upper endcap and the second lower endcap.

### CROSS-REFERENCE TO RELATED CASES

This is a continuation of PCT Application No. PCT/US2023/015106, filed Marsh 13, 2023, which claims priority to and the benefit of Indian Patent Application No. 202241014381, filed on Mar. 16, 2022, entitled DUAL STAGE ADVANCED FUEL WATER SEPARATOR. The contents of these applications are incorporated herein by reference in their entirety.

### FIELD

Embodiments of this disclosure relate generally to a fuel water separator filter.

### BACKGROUND

Fuel water separator filters that filter fuel, for example diesel fuel, and also separates water from the fuel before the fuel is passed to the engine are known. Various conventional fuel water separator filters are generally disposed on the high pressure, or downstream, side of a fuel pump. A number of such fuel water separator filters typically employ an outer diameter seal that forms a seal with an interior surface of a filter housing. Additionally, in various conventional fuel water separator filter designs, an outer diameter of a bottom endplate of the fuel water separator filter typically form a seal with the interior of the filter housing to form a water sump.

### SUMMARY

Embodiments provided herein relate generally to a fuel water separator filter system. More specifically, embodiments relate to a fuel water separator filter that is configured as a dual stage filter with multiple media packs to separate water from the fuel.

In one embodiment, the fuel water separator filter is configured for use on a suction, or low pressure, side of a fuel pump, as opposed to being disposed on the high pressure, or downstream, side of a fuel pump. In other embodiments, the described fuel water separator filter may be disposed on the high pressure side of a fuel pump.

In a particular set of embodiments, a suction side fuel water separator filter includes an outer filter and an inner filter disposed within and spaced apart from the outer filter. The outer filter may include a pleated filter media layer and a coalescing layer on an inner surface of the pleated filter media layer and a hydrophobic screen around wrapped around the outer diameter (e.g., OD) of the inner filter. The inner filter may include at least one of a pleated filter coalescing wrap and a hydrophobic screen filter for additional water separation, and may include a structure that attaches the inner filter to the outer filter.

### BRIEF DESCRIPTION OF THE DRAWINGS

References are made to the accompanying drawings that form a part of this disclosure, and which illustrate the embodiments in which the systems and methods described in this Specification can be practiced. Like reference numbers represent like parts throughout the drawings.

FIG. 1 is a cross-sectional view of a dual stage fuel water separator filter installed in a filter housing, according to an example embodiment.

FIG. 2 is a cross-sectional view of the dual stage fuel water separator filter of FIG. 1.

FIG. 3 is a cross-sectional view of a bottom portion of the dual stage fuel water separator filter installed in a filter housing of FIG. 1.

FIG. 4 is a cross-sectional view of a bottom portion of the filter housing of FIG. 1.

FIG. 5 is a side perspective view of a bottom portion of the filter housing of FIG. 1.

### DETAILED DESCRIPTION OF VARIOUS EMBODIMENTS

Embodiments provided herein relate generally to a fuel water separator filter system. More specifically, the embodiments relate to a fuel water separator filter that is configured as a dual stage advanced fuel water separator construction with multiple filter media packs to provide superior fuel water separation.

In one embodiment, the dual stage fuel water separator filter is configured for use on a suction, or low pressure, side of a fuel pump, as opposed to being disposed on the high pressure side. In some embodiments, the described fuel water separator filter may be disposed on the high pressure side of a fuel pump.

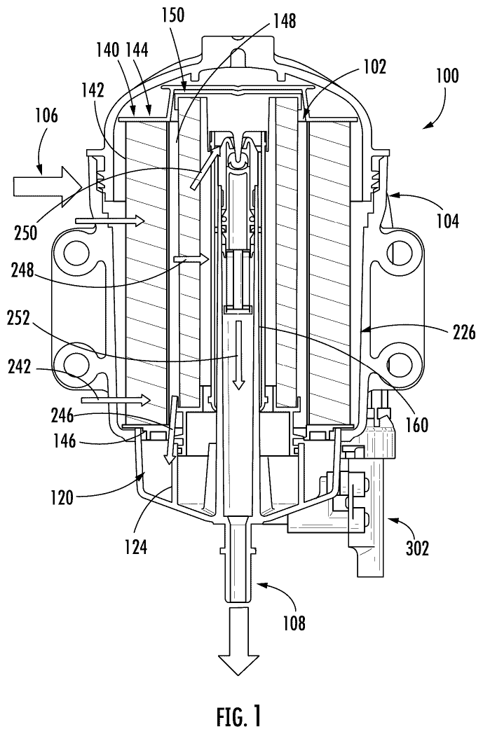

The fuel water separator filter is configured to be housed in a filter housing that is formed with at least two water sumps. The first water sump will collect the water striped by the hydrophobic screen of the outer filter (e.g., first media pack) and the second water sump will collect the water stripped by the inner hydrophobic screen. The two sumps (e.g., the first water sump and the second water sump) are separated from each other by the filter element seals. The filter element seals are provided on the lower endcaps coupled to the first media pack and the second media pack. The filter element seals form sealing engagements with the filter housing and the wall (e.g., wall 124 of FIG. 1) to fluidly separate and fluidly isolate the first water sump from the second water sump.

With reference now to FIG. 1, a filter assembly 100 is illustrated that includes a fuel water separator filter 102 disposed within a filter housing 104. The housing 104 includes an inlet 106 through which fuel contaminated with water may enter, and an outlet 108 through which filtered fuel with water removed may flow downstream, such as to an engine. When used on the suction side, the outlet 108 is connected to a fuel pump (not shown) which pumps the fuel, such as to the engine.

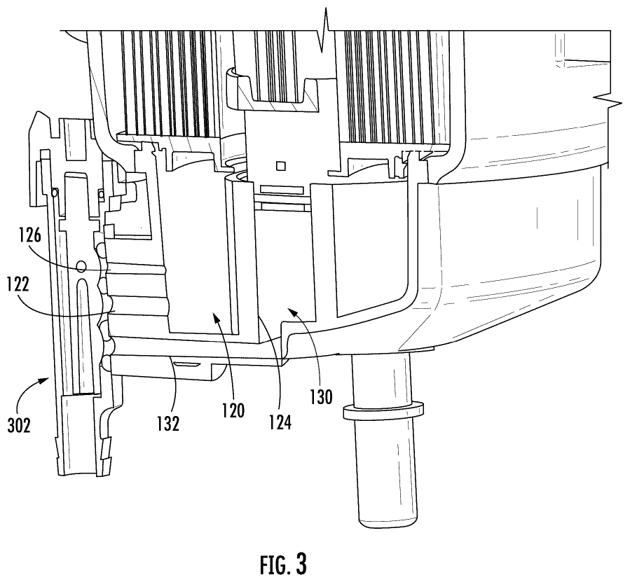

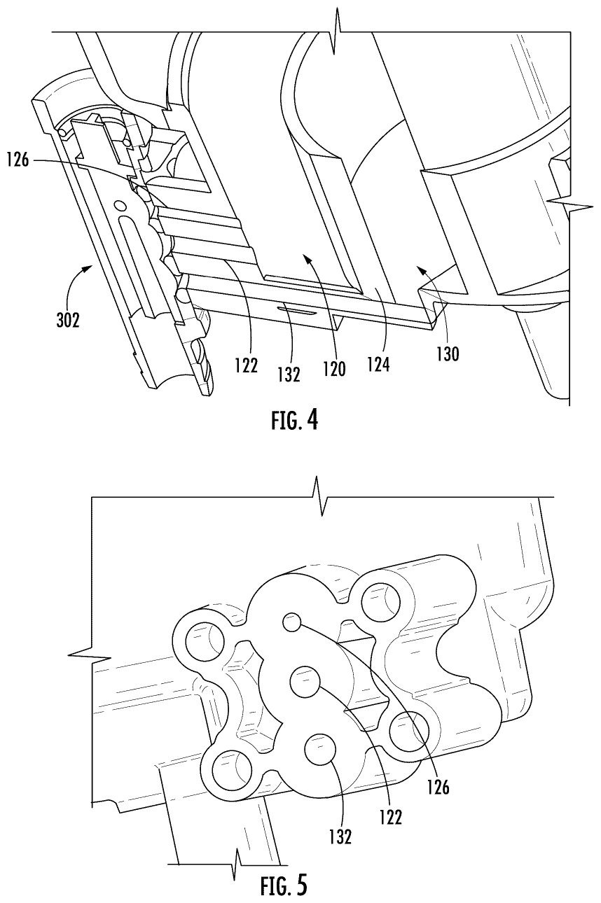

The housing 104 includes a first water sump (e.g., stage one sump, outer sump, etc.) 120 at the base thereof that is configured to collect water that is separated from the fuel by the filter 102. A first drain port 122 (FIG. 3-5) is provided that permits draining of water from the first water sump 120. The first drain port 122 extends radially from the first water sump 120 to an exterior of the filter housing 104. The first water sump 120 is formed by the housing 104 and an annular wall 124 that is disposed radially within the housing 104 and extends axially into the housing 104. The housing 104 further incudes a first vent 126 (FIG. 3-5) that permits venting of air through the housing 104 from the first water sump 120. The first vent 126 extends radially from the first water sump 120 to the exterior of the filter housing 104.

The housing further includes a second water sump (e.g., stage two sump, inner sump, etc.) 130 at the base of the housing 104 that is configured to collect water that is separated from the fuel by the filter 102. The second water sump 130 is positioned radially within the first water sump 120 and the second water sump 130 circumferentially surrounds the outlet 108. In some embodiments, the first water sump 120 has a different volume than the second water sump 130. For example, the first water sump 120 has a first volume and the second water sump 130 has a second volume. In some embodiments, the first volume is greater than the second volume. A second drain port 132 (FIGS. 3-5) is provided that permits draining of the water from the second water sump 130. The second drain port 132 extends radially from the second water sump 130 to the exterior of the filter housing 104. The second water sump 130 is formed by the housing 104 and the annular wall 124 that fluidly isolates the first water sump 120 from the second water sump 130. In some embodiments, the filter 102 forms a sealing engagement with the wall 124 to prevent the water from the first water sump 120 and the second water sump 130 from splashing over the wall 124. In some embodiments, the housing 104 further includes a second vent (not shown) that permits venting of air through the housing 104 from the second water sump 130.

In some embodiments, the filter assembly 100 includes a drain valve 302. The drain valve 302 fluidly couples with the first drain port 122 and the second drain port 132. The drain valve 302 drains the first water sump 120 and the second water sump 130. In some embodiments, the drain valve 302 drains the first water sump 120 and the second water sump 130 based on a level of water in the first water sump 120.

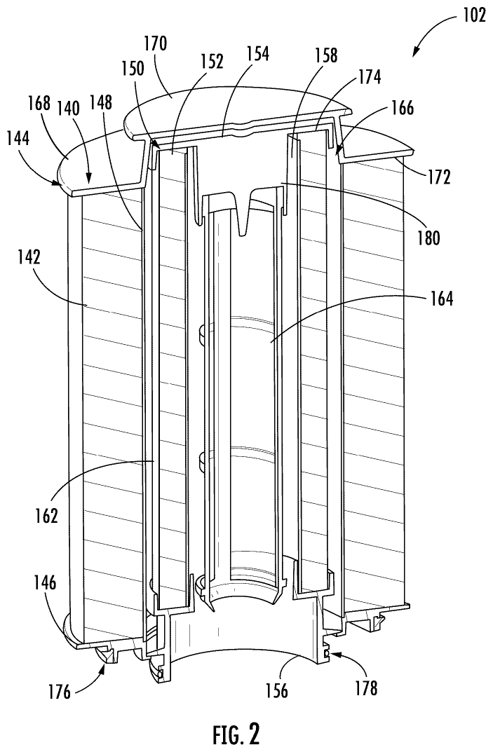

Referring now to FIG. 2, a cross-sectional view of the filter 102 is shown, according to an example embodiment. The filter 102 is a two-part filter that includes a first stage (e.g., outer stage) 140 and a second stage (e.g., inner stage) 150. In embodiments where the filter 102 is an outside-in filter, the incoming fuel enters the first stage 140, continues to flow through the second stage 150, and then the clean, separated fuel flows through a center pipe 160 and through the outlet 108. The first stage 140 includes a first media pack 142 coupled to first endcaps 144, 146, and a first coalescing wrap 148. The first endcaps 144, 146 include a first upper endcap 144 and a first lower endcap 146. The first coalescing wrap 148 is coupled proximate an inner surface of the first media pack 142. The first coalescing wrap 148 is coupled to both the first upper endcap 144 and the first lower endcap 146. The first coalescing wrap 148 is configured to coalesce moisture (e.g., water) from a flow of fuel, and then the first hydrophobic screen 162, which is located at the outer diameter of the second stage 150, will separate the coalesced water and provide the coalesced water to the first water sump 120. The second stage 150 is positioned radially within the first stage 140 and is surrounded by the first media pack 142 such that the second stage 150 receives a flow of fluid from the first media pack 142 and the first hydrophobic screen 162. The second stage 150 includes a second media pack 152 coupled to second endcaps 154, 156, and a second coalescing wrap 158. The second endcaps 154, 156 include a second upper endcap 154 and a second lower endcap 156. The second coalescing wrap 158 is coupled proximate to an inner surface of the second media pack 152. The second coalescing wrap 158 is configured to coalesce moisture (e.g., water) from a flow of fuel, then the second hydrophobic screen 164 will provide the moisture to the second water sump 130.

In some embodiments, the second media pack 152 is offset from the first media pack 142. For example, the at least a portion of the second media pack 152 is disposed axially outside of the first media pack 142. The first upper endcap 144 can define a pocket 166 to receive the portion of the second media pack 152 that extends beyond the first media pack 142. For example, the first upper endcap 144 includes an outer portion 168 and an inner portion 170. The outer portion 168 is coupled with the first media pack 142. The inner portion 170 extends axially from the outer portion 168 away from the first media pack 142. The inner portion 170 defines the pocket 166 to receive the portion of the second media pack 152. For example, the first media pack 142 comprises a first upper media pack end 172 and the second media pack 152 comprises a second upper media pack end 174. The second upper media pack end 174 is offset from the first upper media pack end 172. The second upper media pack end 174 is coupled with the second upper endcap 154. The second upper media pack end 174 and the second upper endcap 154 are disposed in the pocket 166 of the first upper endcap 144.

At least one of the lower endcaps 146, 156 can create a sealing engagement with the housing 104. For example, the first lower endcap 146 comprises a first sealing component 176. The first sealing component 176 forms a scaling engagement with the housing 104. The second lower endcap 156 comprises a second sealing component 178. The second sealing component 178 forms a sealing engagement with the annular wall 124 of the housing 104. In some embodiments, the first sealing component 176 is axially offset from the second scaling component 178. For example, the second sealing component 178 may be disposed closer to a bottom or lower end of the housing 104 than the first sealing component 176.

The filter 102 further includes a first hydrophobic screen 162 positioned between the first media pack 142 and the second media pack 152. The filter 102 further includes a second hydrophobic screen 164 positioned radially within the second media pack 152 and positioned between the second media pack 152 and the center pipe 160. The second hydrophobic screen 164 may be coupled to the center pipe 160 positioned within the second media pack 152 and coupled to the second upper endcap 154. In some embodiments, the second upper endcap 154 comprises a central protrusion 180. The central protrusion 180 is positioned radially within the second media pack 152. The second hydrophobic screen 164 is coupled with the second upper endcap 154 via the central protrusion 180.

In some embodiments, the first stage 140 and the second stage 150 have different micron rates. The different micron rates can increase contamination capacity of the filter 102, which can maintain a longer filter life of the filter 102. For example, the first stage 140 has a first micron rate and the second stage 150 has a second micron rate. In some embodiments, the first micron rate is greater than the second micron rate. The first stage 140 with the larger micron rate can remove larger particles from the fuel and the second stage 150 can remove smaller particles such that both filters contribute to the filtration of the fuel.

With reference to FIG. 1 and the flow paths shown therein, the incoming fuel enters the filter chamber 226 which is separated from the first water sump 120 by the first lower endcap 146. The fuel flows into an area outside the filter 102 and then through the first media pack 142 as shown by the unfiltered fuel flow path 242. Water that is coalesced from the fuel by the first stage 140 and the coalescing wrap 148 striped by the hydrophobic screen and sinks to the first water sump 120. The fuel passes through the first media pack 142 and then to the first coalescing wrap 148 which coalesces water within the fuel to form large water droplets that sink to the base of the housing 104 and through suitable passageways in the first lower endcap 146 into the first water sump 120 as shown by the water droplet flow path 246. The fuel then flows toward the second stage 150 and through the first hydrophobic screen 162 as shown by the intermediate fuel flow path 248 and any additional water droplets in the fuel are stripped out by the first hydrophobic screen 162 and sink down into the first water sump 120.

The fuel then flows through the second media pack 152 as shown by the flow path 248. Water that is stripped from the fuel by the second stage 150 sinks to the second water sump 130. The fuel passes through the second media pack 152 and then to the second coalescing wrap 158 which coalesces water within the fuel to form large water droplets that sink to the base of the housing 104 and through suitable passageways in the second lower endcap 156 into the first water sump 120 as shown by the water droplet flow path 246. The fuel then flows through the second hydrophobic screen 164 as shown by the fuel flow path 250 and any additional water droplets in the fuel are stripped out by the second hydrophobic screen 164 and sink down into the second water sump 130.

The filtered fuel then flows into the center pipe 160 (e.g., a standpipe structure) of the filter housing 104 which forms part of the outlet 108 along the filtered fuel flow path 252. The first lower endcap 146 and the second lower endcap 156 may form a seal against a wall of the water sump (e.g., the wall 124 that separates the first water sump 120 from the second water sump 130) to prevent unfiltered fuel and water from bypassing the filter 102.

The filter housing 104 may include an upper housing and a lower housing that are detachably connected together and sealed to one another at a connection point. The upper housing and the lower housing may be detachably connected to one another using any suitable attachment mechanism, for example a clamp mechanism, bolts, or any other mechanism known in the art. The lower housing may include both the inlet 106 and the outlet 108.

The filter housing may be pre-formed with the first water sump 120 and the second water sump 130, or an existing filter housing may be modified to create the first water sump 120 and the second water sump 130. The first water sump 120 and the second water sump 130 may be formed in the lower housing by modifying an existing lower housing. In particular, the wall 124 may be a structure that is installed within the lower housing to create the first water sump 120 and the second water sump 130.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “approximately,” “generally,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

What is claimed:

1. A fuel water separator filter, comprising:
a first stage comprising:
a first media pack coupled to a first upper endcap and first lower endcap;
a first coalescing wrap coupled proximate to an inner surface of the first media pack and coupled to both the first upper endcap and the first lower endcap.
a second stage comprising:
a second media pack positioned within the first media pack and coupled to a second upper endcap and a second lower endcap;
a second coalescing wrap coupled proximate to an inner surface of the second media pack and coupled to both the second upper endcap and the second lower endcap;
a first hydrophobic screen positioned between the first stage and the second stage; and
a second hydrophobic screen positioned radially within the second stage.

2. The fuel water separator filter of claim 1, wherein at least one of the first lower endcap or the second lower endcap are configured to form a seal with a wall of a housing to prevent water from splashing between a first water sump and a second water sump of the housing.

3. The fuel water separator filter of claim 1, wherein the second media pack is offset from the first media pack such that at least a portion of the second media pack is disposed axially outside of the first media pack.

4. The fuel water separator filter of claim 1, wherein the first upper endcap comprises an outer portion and an inner portion, the outer portion coupled with the first media pack and the inner portion extending axially from the outer portion away from the first media pack, the inner portion defining a pocket to receive a portion of the second media pack.

5. The fuel water separator filter of claim 4, wherein the first media pack comprises a first upper media pack end and the second media pack comprises a second upper media pack end, the second upper media pack end axially offset from the first upper media pack end such that the second upper media pack end and the second upper endcap are disposed in the pocket of the first upper endcap.

6. The fuel water separator filter of claim 1, wherein:
the first lower endcap comprises a first sealing component; and
the second lower endcap comprises a second sealing component, the first sealing component axially offset from the second sealing component.

7. The fuel water separator of claim 1, wherein the second upper endcap comprises a central protrusion positioned radially within the second media pack, the second hydrophobic screen coupled to the second upper endcap via the central protrusion.

8. The fuel water separator filter of claim 1, wherein the first stage comprises a first micron rate and the second stage comprises a second micron rate, the first micron rate greater than the second micron rate.

9. A fuel water separator system, comprising:
a housing having a first water sump and a second water sump fluidly separated by an annular wall; and
a filter comprising:
a first stage configured to provide water to the first water sump, the first stage comprising:
a first media pack coupled to a first upper endcap and first lower endcap; and
a first coalescing wrap coupled proximate to an inner surface of the first media pack and coupled to both the first upper endcap and the first lower endcap;
a second stage configured to provide water to the second water sump, the second stage comprising:
a second media pack positioned within the first media pack and coupled to a second upper endcap and a second lower endcap; and
a second coalescing wrap coupled proximate to an inner surface of the second media pack and coupled to both the second upper endcap and the second lower endcap;
a first hydrophobic screen positioned between the first stage and the second stage; and
a second hydrophobic screen positioned radially within the second stage.

10. The fuel water separator system of claim 9, wherein the filter forms a sealing engagement with the annular wall to fluidly isolate the first water sump from the second water sump.

11. The fuel water separator system of claim 9, wherein the first lower endcap comprises a first sealing component and the second lower endcap comprises a second sealing component, the first sealing component forming a first sealing engagement with the housing and the second sealing component forming a second sealing engagement with the annular wall.

12. The fuel water separator system of claim 9, wherein the first water sump is formed by the housing and the annular wall, the annular wall disposed radially within the housing and extends axially into the housing toward the filter.

13. The fuel water separator system of claim 12, wherein the housing comprises an outlet, the second water sump circumferentially surrounding the outlet and positioned radially within the first sump.

14. The fuel water separator system of claim 9, wherein the housing comprises:
a first drain port to permit draining of water from the first water sump, the first drain port extending radially from the first water sump to an exterior of the housing; and
a second drain port to permit draining of water from the second water sump, the second drain port extending radially from the second water sump to the exterior of the housing.

15. The fuel water separator system of claim 14, further comprising a drain valve fluidly coupled with the first drain port and the second drain port, the drain valve configured to drain the first water sump and the second water sump at the same time.

16. The fuel water separator system of claim 15, wherein the drain valve is configured to drain the first water sump and the second water sump based on a level of water in the first sump.

17. The fuel water separator system of claim 9, wherein the housing comprises a vent, the vent permitting a venting of air through the housing from the first water sump, the vent extending radially from the first water sump to an exterior of the housing.

18. The fuel water separator system of claim 9, wherein:
the housing comprises a center pipe positioned within the second media pack; and
the second upper endcap comprises a central protrusion positioned within the second media pack; and
the second hydrophobic screen is coupled to the second upper endcap via the central protrusion and the center pipe.

19. The fuel water separator system of claim 9, wherein the first water sump has a first volume and the second water sump has a second volume, the first volume greater than the second volume.

20. The fuel water separator system of claim 9, wherein the second media pack is offset from the first media pack such that at least a portion of the second media pack is disposed axially outside of the first media pack.
